(19) United States
(12) Patent Application Publication
(10) Pub. No.: US 2025/0137152 A1
(43) Pub. Date: May 1, 2025

(54) METHOD AND STRUCTURE FOR EXTREME WEATHER HYDROGEN GENERATION FACILITY

(71) Applicant: Ohmium International, Inc., Newark, CA (US)

(72) Inventors: Arne Ballantine, Incline Village, NV (US); Rasool Aghatehrani, Redwood City, CA (US); Celeste Mueller, Boston, MA (US); Tom Miller, San Jose, CA (US)

(21) Appl. No.: 18/929,045

(22) Filed: Oct. 28, 2024

Related U.S. Application Data
(60) Provisional application No. 63/593,305, filed on Oct. 26, 2023.

(51) Int. Cl. C25B 15/08

(52) U.S. Cl. CPC C25B 15/08

(57) ABSTRACT

A hydrogen generation system suitable for outdoor use is described. The system vents to the atmosphere to help to prevent accumulation of hazardous gas buildup within the system while also protecting hydrogen generation components from extreme weather conditions. The system includes walls that the allow ventilation while inhibiting moisture and wind from entering an interior of the system.

### CROSS-REFERENCE TO RELATED APPLICATIONS

This application claims priority to U.S. Provisional Application No. 63/593,305 titled “Method and Structure for Extreme Weather Hydrogen Generation System” filed Oct. 26, 2023, the entire contents of which are incorporated by reference herein.

### FIELD OF THE DISCLOSURE

The present disclosure is directed to methods and structures for extreme weather hydrogen generation facilities.

### BACKGROUND

When cabinets containing hydrogen electrolyzers are placed in the outside environment, they are prone to extreme weather conditions such as high winds, heavy rain, snow, extreme temperatures, and storms. These adverse conditions are hazardous to the cabinets and hamper the performance of the electrolyzers, resulting in reduced yield. There are problems of wind deflection, windborne debris, snow, sand, horizontal rain, or other weather elements entering the cabinets. Sand and debris can accumulate on conductors and insulators inside the cabinets, potentially leading to short circuits. Wind and rain can transport pollutants or corrosive agents which leads to corrosive effects on exposed surfaces. Accumulated snow adds weight and stress to roofs, structures, and support systems, leading to structural damage or collapse or in some cases electrical hazards. Moreover, placing hydrogen generators indoors requires installation of sophisticated ventilation systems to prevent accumulation of a combustible mixture of gases, thus increasing costs.

### SUMMARY

Provided herein is a hydrogen generation system suitable for outdoor use. The system vents to the atmosphere to help to prevent accumulation of hazardous gas buildup within the system while also protecting hydrogen generation components from extreme weather conditions. The system includes walls that allow ventilation while inhibiting moisture and wind from entering an interior of the system. The system includes hydrogen cabinets positioned around a central duct to provide for ventilation of gases from the hydrogen cabinets.

Further provided herein is a hydrogen generation system. The system comprises a plurality of hydrogen cabinets. Each hydrogen cabinet comprises a hydrogen generator. The system comprises a plurality of electronics cabinets. The plurality of hydrogen cabinets and the plurality of electronic cabinets are positioned around a central duct. Each hydrogen cabinet is fluidly connected to the central duct. Ventilated gases from the plurality of hydrogen cabinets are directed to the central duct.

Further provided herein is a hydrogen generation system for use during extreme weather conditions. The system comprises a ceiling structure generally opposite of a bottom structure. Exterior walls join the ceiling structure and the bottom structure. An interior is defined by the ceiling structure, the bottom structure, and the exterior walls. The exterior walls include wall elements configured to permit incoming air to move through the exterior walls while hindering movement of wind, moisture, or pollutants through the exterior walls. The system comprises a plurality of hydrogen cabinets. Each hydrogen cabinet comprises a hydrogen generator. The system comprises a plurality of electronics cabinets. The plurality of hydrogen cabinets and the plurality of electronic cabinets are positioned in the interior. Each hydrogen cabinet is fluidly connected to a central duct. Ventilated gases from the plurality of hydrogen cabinets are directed to the central duct.

### BRIEF DESCRIPTION OF THE FIGURES

The various objects, features, and advantages of the present disclosure set forth herein will be apparent from the following description of embodiments of those inventive concepts, as illustrated in the accompanying drawings. It should be noted that the drawings are not necessarily to scale and may be representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting.

FIG. 1 shows a diagram of the system of the present disclosure.

FIG. 2 shows a top view of the system with central ducts venting to the atmosphere.

FIG. 3 shows a top view of the system with the ceiling structure omitted to show the interior.

FIG. 4 shows a perspective view of the baffling walls.

FIG. 5 shows a diagram with walls having perforated structures.

FIG. 6 shows a view of the baffling walls with interlocking structures.

FIG. 7 shows a view of waste heat utilization.

FIG. 8 shows a view of the system with a first louver design.

FIG. 9 shows a view of the system with a second louver design.

FIG. 10 shows a front view of a single-story facility with multiple systems using the first louver design.

FIG. 11 shows a side view of the single-story facility with multiple systems using the first louver design.

FIG. 12 shows a front view of a single-story facility with multiple systems using the second louver design.

FIG. 13 shows a side view of the single-story facility with multiple systems using the second louver design.

### DETAILED DESCRIPTION

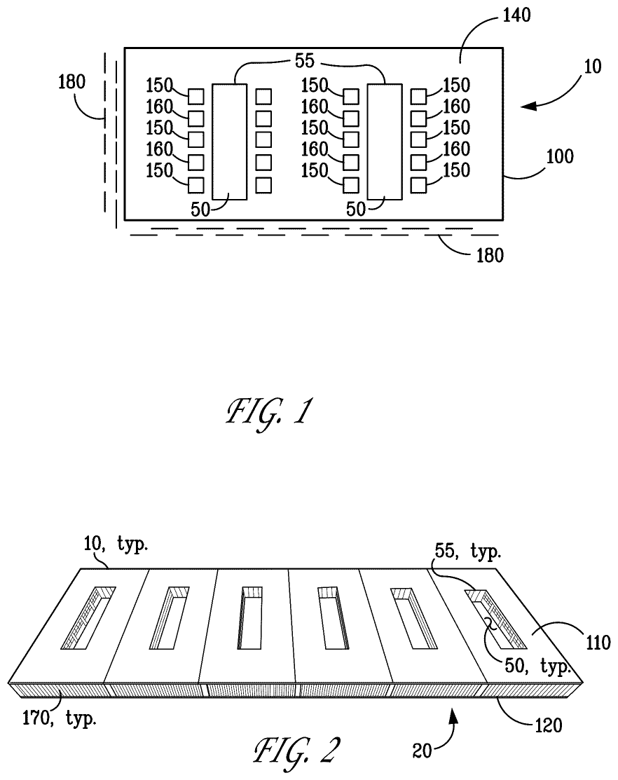

The present disclosure is directed to a hydrogen generation system 10 suitable for outdoor use. The system 10 vents to the atmosphere to help to prevent accumulation of hazardous gas buildup within the system 10 while also protecting hydrogen generation components from extreme weather conditions. FIG. 1 shows an example of the hydrogen generation system 10 with a central duct 50. FIG. 2 shows a top view of the system 10 with the central duct 50 being open to atmosphere. In view of the ventilation requirements needed for hydrogen generation, the system 10 is configured to provide necessary ventilation for the system 10 while withstanding weather conditions and providing protection for the electrical components of the system 10. The system 10 provides resistance to weather conditions and maintains sufficient airflow to the system 10 to help ensure safety and reliability.

The system 10 includes a plurality of hydrogen cabinets 150 and a plurality of electronics cabinets 160. The plurality of hydrogen cabinets 150 are positioned to fluidly connect with the central duct 50. Each hydrogen cabinet is fluidly connected to the central duct 50. Ventilated gases from the plurality of hydrogen cabinets 150 are directed to the central duct 50. The ventilated gases may include ambient air, oxygen gas generated during electrolysis, hydrogen gas generated during electrolysis, water vapor, or a combination thereof.

A facility or island 20 may include one or more of the systems 10. The facility or island 20 may include one or more additional systems 10 positioned next to each other or placed in closed proximity. Each system 10 may include a modular structure with its own plurality of hydrogen cabinets 150 and plurality of electronic cabinets 160. The plurality of hydrogen cabinets 150 are positioned to fluidly connect with the central duct 50 of the respective system 10.

The system 10 comprises the plurality of hydrogen cabinets 150. Hydrogen cabinets have been described in the art, for example, in US 20210156038 A1, the entire contents of which are incorporated by reference herein. The hydrogen cabinets 150 of the present disclosure comprise a hydrogen generator. In some embodiments, the hydrogen generator may be an electrolyzer, such as a proton exchange membrane based electrolyzer. In some embodiments, when the hydrogen generator is an electrolyzer, the hydrogen cabinet may be operable to separate the hydrogen and oxygen generated by the electrolyzer to avoid forming a combustible mixture within the cabinet.

The system 10 further comprises a plurality of electronics cabinets 160, which condition the electricity going the plurality of hydrogen cabinets 150. Each of the plurality of electronics cabinets 160 includes AC-DC and DC-DC power converters that are necessary to provide power to each of the plurality of hydrogen cabinets. Additionally, each electronics cabinet 160 may include internal fans that draw air from the environment and blow it across the electronic components within the cabinet to cool the electronic components. This generates exhaust comprising warmed air. The warmed air may be exhausted to the surrounding area to prevent any flow of hydrogen or oxygen from the plurality of hydrogen cabinets 150 into the electronics cabinets 160. In some embodiments, the plurality of electronics cabinets 160 may be fluidly connected to the central duct 50, and the warmed air may be exhausted into the central duct 50.

Generally, the number of hydrogen cabinets 150 and the number of electronics cabinets 160 in the system 10 is equal. However, some embodiments may include more hydrogen cabinets 150 than electronics cabinets 160. The system 10 may include two to approximately 20 or more hydrogen cabinets 150 and electronics cabinets 160. As described above, the facility or island 20 may include several additional systems 10 positioned next to each other or placed in closed proximity. For example, FIG. 2 illustrates an exemplary facility 20 that includes six systems 10.

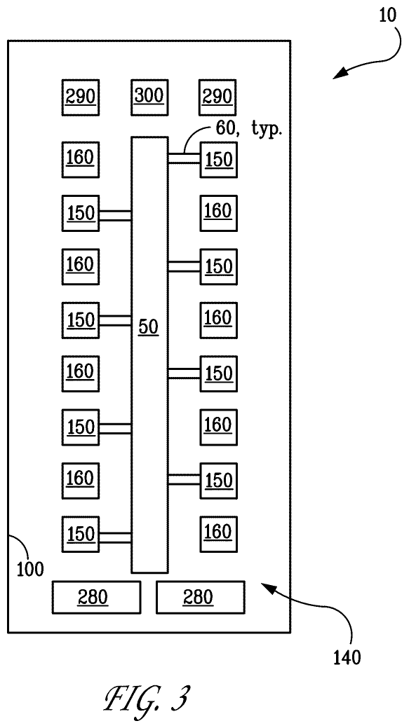

In some embodiments, the plurality of hydrogen cabinets 150 and the plurality of electronics cabinets 160 may be placed in an alternating pattern in the system 10 as shown in FIG. 3. The alternating pattern may position the plurality of hydrogen cabinets 150 and the plurality of electronic cabinets 160 around the central duct 50. By positioning the plurality of hydrogen cabinets 150 and the plurality of electronic cabinets 160 around the central duct 50, the air flow through to the central duct 50 is improved and space is used efficiently. In some embodiments, the hydrogen cabinets 150 and the number of electronics cabinets 160 are positioned on opposite sides of the central duct 50. The central duct 50 may include a cross-section with generally a rectangular shape as illustrated. In this embodiment, the central duct 50 includes two, shorter end walls and two, longer sidewalls. In other embodiments the central duct 50 may include a cross-section with an oblong, squared, geometric, or non-geometric shape.

The central duct 50 is intended as a non-access duct structure for venting and airflow purposes only. A grating may be installed over an upper opening 55 of the central duct 50 for safety purposes.

The central duct 50 provides for high air flow to prevent gas concentrations from accumulating in the system 10 and/or hydrogen cabinets 150. The central duct 50 vents to the atmosphere. This high air flow is important for preventing the buildup of gas concentrations, ensuring good air quality within the system 10, and reducing the risk of pollutants or contaminants accumulating within the system 10. The central duct 50 typically accepts ventilation and/or exhaust from the hydrogen generators that potentially contains concentrated gases (hydrogen, oxygen, for example) and directs the ventilation and/or exhaust to the atmosphere. The central duct 50 includes the upper opening 55 at a top of the system 10, and the central duct 50 directs the ventilation gases to the upper opening 55 at the top of the system 10 to provide for natural dissipation of the ventilation gases to the atmosphere. The upper opening 55 may be flush with the top of the system 10. The central duct 50 may contain additional weather protection measures such as baffles, which are detailed below. As shown in FIG. 3, the system 10 may include a plurality of secondary ducts 60 fluidly connecting the central duct 50 to each of the plurality of hydrogen cabinets 150. In some embodiments, the central duct 50 may have a typical height of approximately 4 to 5 meters. In multi-story systems 10, the central duct 50 may extend through both a first story and additional upper stories and include a greater height.

With reference to FIG. 3, the system 10 is illustrated. The system 10 includes exterior walls 100 joining a ceiling structure 110 and a bottom structure 120. The ceiling structure 110 is generally opposite of the bottom structure 120. The exterior walls 100 generally define a perimeter of the system 10. A combination of the exterior walls 100, the ceiling structure 110 and the bottom structure 120 define an interior 140. The system 10 is configured to contain the plurality of hydrogen cabinets 150 and the plurality of electronics cabinets 160 in the interior 140 to shield these components from the environment. Each hydrogen cabinet 150 includes a hydrogen generator. The central duct 50 extends to the ceiling structure 110, and the upper opening 55 may be defined by or at the ceiling structure 110.

The exterior walls 100 may include wall elements 170 to permit incoming air to move through the exterior walls 100 while hindering the movement of wind, moisture, debris, and/or pollutants. The wall elements 170 permit the high air flow needed by the system 10 for hydrogen generation while limiting the entry of wind, moisture, debris, and/or pollutants into the interior 140 of the system 10. The wall elements 170 may protect the plurality of hydrogen cabinets 150 and the plurality of electronics cabinets 160 from direct contact with wind, moisture, debris, or pollutants.

The wall elements 170 may extend all or most of a height and/or a width of the exterior walls 100. The wall elements 170 generally include openings, gaps, slots, etc. between respective wall elements 170 to provide for the air flow to pass into the interior 140 of the system 10. The wall elements 170 help prevent buildup of pollutants and combustible gases in the system 10 by allowing the airflow. The wall elements 170 may also physically block debris or otherwise slow the movement of the debris, such as sand, dust, dirt, leaves, etc. inward toward the interior 140 of the system 10.

The wall elements 170 may include a variety of shapes and designs configured to permit the high air flow needed by the system 10 for hydrogen generation while limiting or inhibiting the entry of wind, moisture, pollutants carried by the moisture, and/or debris into the interior 140 of the system 10. For example, the exterior walls 100 may include wall elements 170 arranged vertically, diagonally, horizontally or combinations thereof. For example, the exterior walls 100 may include one or more wall elements 170 such as, baffles, baffling structures, louvers, shutters, slats, etc. For example, the wall elements 170 may include perforations, lattices, openings, or combinations thereof. For example, the exterior walls 100 may include single layers of wall elements 170 or multiple layers of wall elements 170. The resistance encountered by incoming air as it passes off of the wall elements 170 helps to knock water, dust, or snow out of the air, but the resistance should be low enough to ensure that the ventilation system operates efficiently, with minimal energy consumption required to move air through the system 10. High air flow through the system 10 also helps to maintain a comfortable and safe interior environment by providing adequate ventilation.

The wall elements 170 may include removable, replaceable and adjustable configurations. The wall elements 170 may be formed from weather resistant materials and/or typical materials used in exterior construction. The wall elements 170 may be replaced with different wall elements 170 depending upon the season or expected weather condition. The wall elements 170 may be customized for the geography of the intended location of the system 10. The wall elements 170 may be formed into panels that are received by the exterior walls 100. An individual system 10 may include different wall elements 170 for each side of the system 10 depending upon the orientation of the system 10.

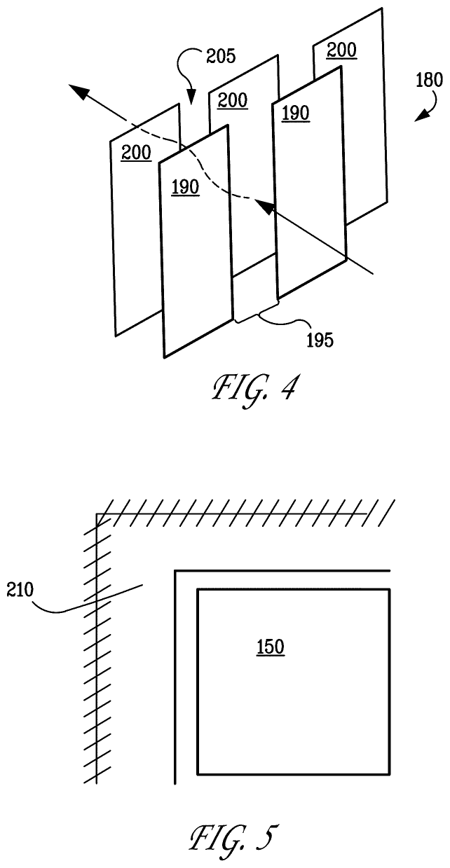

With reference to FIG. 4, in one exemplary embodiment, a plurality of low pressure drop baffling walls 180 may be included in the exterior walls 100, which may contain multiple layers of baffling walls to protect against multiple different weather conditions. This may include multiple layers of baffling walls of the same design, or of multiple layers of baffling walls of different designs, or both. For example, one layer of baffling walls could be optimized for preventing water ingress, while the second layer of baffling walls is designed to prevent dust ingress, and so on. In FIG. 4, the incoming air flow is baffled through a first layer 190 of baffling walls and a second layer 200 of baffling walls. An opening 195 of first layer 190 is offset from an opening 205 of the second layer 200. The offset positioning of the openings 195 and 205 slows the incoming airflow as the airflow must change directions to pass into the interior 140. This may also physically prevent precipitation or debris from entering into the interior 140 of the system 10.

With reference to FIG. 5, in another exemplary embodiment, baffling walls 210 with perforated structures may be employed to block and/or redirect wind. Extreme weather conditions can include not only high winds but also various entrained media like hot air, cold air, water spray, dust, snow, or other particles. The baffling walls 210 with perforated structures, as shown in FIG. 5, may also include a snow fence, a dust fence, and/or a bug screen. The baffling walls 210 help to minimize the impact of these weather elements on the system 10 and thus enhancing its resilience. The baffling walls 210 may include openings between portions of the baffling walls 210. The baffling walls 210 may include integral openings formed in the baffling walls. The openings mays range in size from approximately one inch to approximately one foot in size.

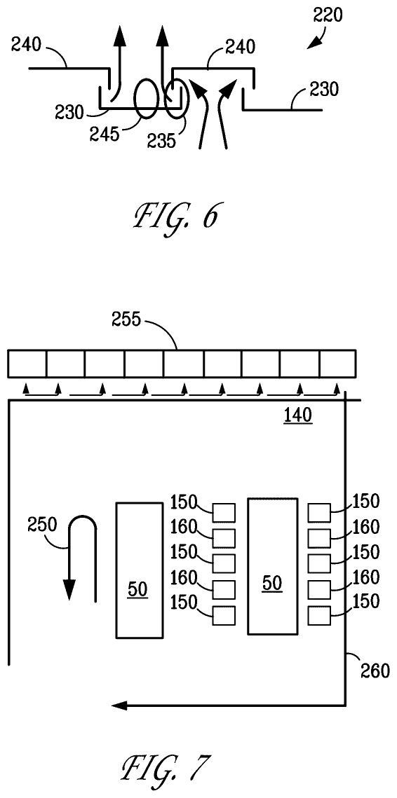

With reference to FIG. 6, in another exemplary embodiment, baffling walls 220 with an interlocking structure are illustrated. To enhance the efficiency of wind diversion and pressure reduction, complex interlocking baffling walls can be employed, such as the baffling walls 220. The baffling walls 220 are designed to create zones of high and low air velocity, which can be strategically utilized to optimize ventilation and weather protection. As shown in FIG. 6, the incoming air enters a first layer 230 of the baffling walls 220 at high speed in a high velocity zone 235 and once it hits a second layer 240, the incoming air gets diverted and drops the foreign particles in a low velocity zone 245.

In other embodiments, shutter structures are employed in exterior walls 100 to allow for service when the structure or a portion of the structure is not in use (e.g., construction or shutdown). The shutter structure may be integrated into the exterior walls 100 to allow for temporary closure during construction, maintenance, or shutdown periods. The shutter structures may be configured to move between open and closed positions with respect to the exterior walls 100. The shutter structures may be configured to cover and uncover openings in the exterior walls 100. These shutter structures may be configured to allow minimal to no airflow from the outside when needed. In other embodiments, the exterior walls 100 may include the interchangeable panels that would allow for the system to be periodically changed or updated to account for different hazards. For example, a paneling system can be installed in the summer to protect against strong winds and dust and changed for the winter to protect against cold weather and snow.

With reference to FIG. 7, in another exemplary embodiment, the exterior walls 100 utilize waste heat from various sources within the system 10 to pre-heat incoming air. This helps in maintaining a comfortable indoor temperature even in extreme weather conditions. The system can include two or more sets of radiators 255 that can direct waste heat to the walls 100 when the temperature is low and divert it towards the central duct 50 when the temperature is high, ensuring efficient use of available energy resources. In FIG. 7, a first glycol loop 250 and a second glycol loop 260 take up the heat from the system 10 and emit the heat to the outside environment whereas there is incoming cold air to maintain the indoor environment at optimal temperature.

With reference to FIG. 7, in another exemplary embodiment, the exterior walls 100 may include louvres 270 as baffling elements. The louvres 270 may be oriented horizontally, vertically, or in complex shapes like diagonal arrangements. The louvres 270 may be sized and shaped in various designs, which allows the baffling design to be optimized based on the specific weather concern for the location. The louvres 270 can be adjusted to control the direction and speed of air, making them versatile components for optimizing ventilation and protection against extreme weather.

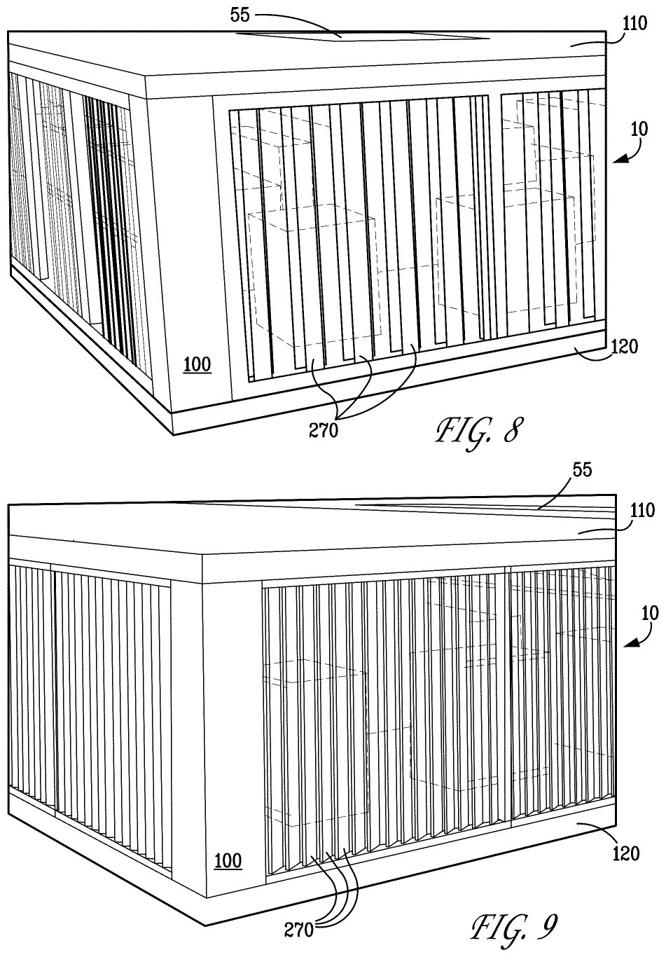

With reference to FIGS. 8 and 9, examples of two different louvre designs are shown. In these embodiments, the louvers 270 include a vertical orientation with gaps in between adjacent louvers 270.

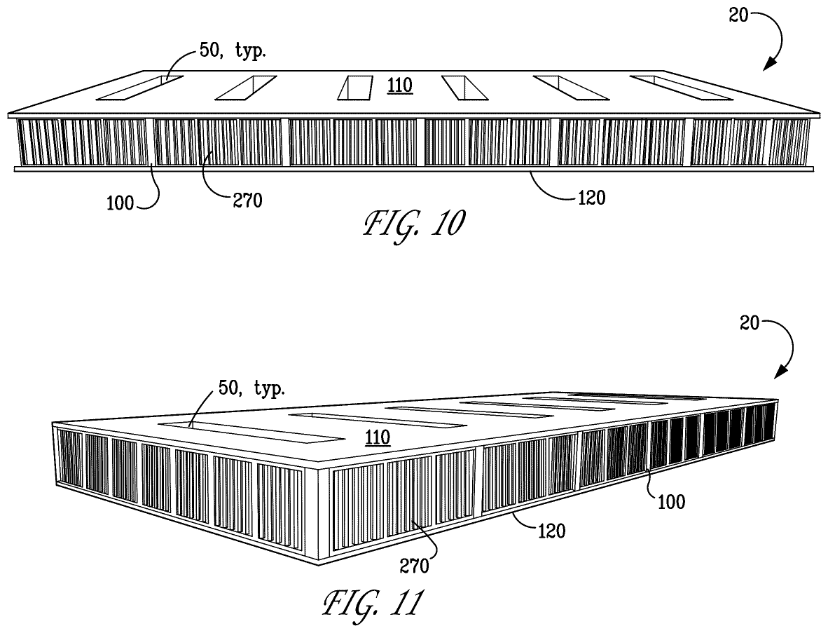

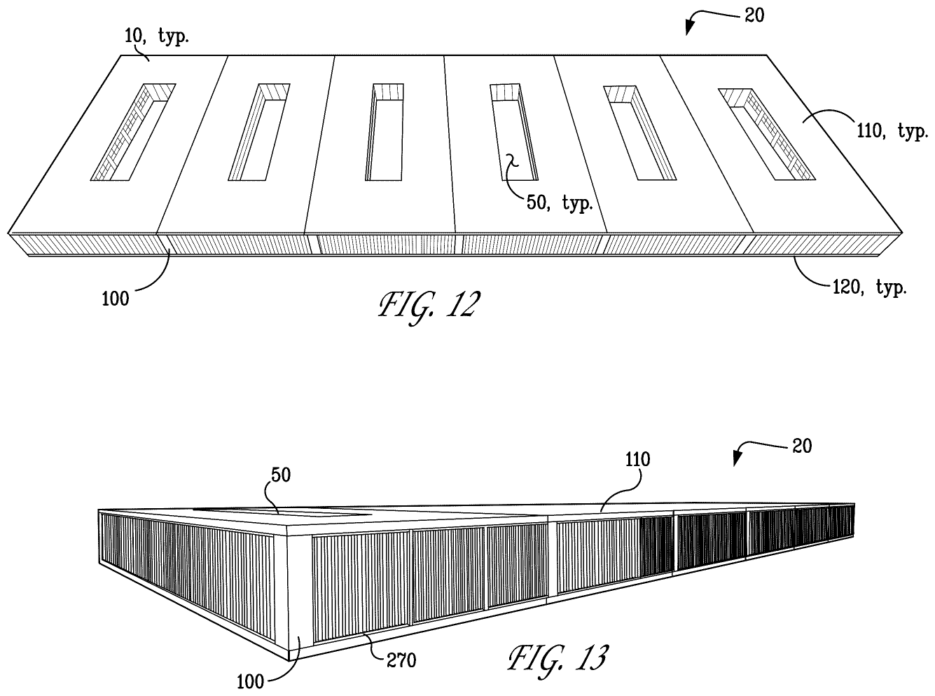

With reference to FIGS. 9 and 10, the system 10 is shown as single-story structure. The plurality of hydrogen cabinets 150 and the plurality of electronics cabinets 160 are installed on the bottom structure 120. The central duct vents through the ceiling structure 110. In this approach, the cabinets 150 and 160 are placed in the ground level without increasing the vertical profile of the structure. Photovoltaic panels may be installed on the ceiling structure 110 of the structure. With its low profile, the single-story structure of the system 10 is less vulnerable to high winds and damage.

In other embodiments, the system 10 is portable and may be moved from one location to another. In other embodiments, the system 10 is positioned on support structures. For example, the system 10 may be installed on an offshore platform or a ship, and the wall elements 170 could protect against weather and also sea spray and/or waves.

In other embodiments, the system 10 may include multiple stories. Each story may include its own plurality of hydrogen cabinets 150, plurality of electronics cabinets 160, wall elements 170, baffles and/or baffle systems described herein. An optional elevator may be installed or employed with the system 10 or the facility 20.

In other embodiments, the system 10 may include a drainage, a dump, or fallout area. This structure is designed to direct and/or collect the material that is knocked out of the air by the wall elements 170 or louvres/baffles. This helps prevent any of the material accumulating and inadvertently entering the system 10, as well as prevent any accumulation leading to blocking of the wall elements 170. Also, this would allow for easy cleaning and maintenance procedures on the wall elements 170 and the system 10 itself.

As shown in FIG. 3, the system 10 may include one or more distribution cabinets 280, water cabinets 290, and glycol cabinets 300. The system 10 may further shelter other components and systems in its interior 140. For example, power transformers may be installed in the interior 140. The system 10 shields the transformers from direct exposure to the weather elements preventing electrical hazards. This ensures continuous supply of electricity even during adverse weather conditions. For example, hydrogen compressors may be installed in the interior 140. The system 10 helps to ensure safety and reliability of hydrogen compressor systems preventing leaks in harsh weather conditions.

In other embodiments, the ceiling structure 110 may include solar panels that feeds back power (or helps power) the equipment internal to the system 10, or any portion of the panels or building itself that requires power.

The system 10 may include additional heating system inside the interior 140. The additional heating system within the structure serves as a backup source of heat during extreme cold weather conditions. It provides redundancy and reliability in maintaining a suitable temperature inside the system.

In other embodiments, the wall elements 170, such as louvers, are designed based on seasonal considerations. For example, during the winter, the louvers may be adjusted to reduce the entry of cold air while still providing ventilation. In the summer, the louvers may allow for increased airflow to cool the interior 140. This approach optimizes energy efficiency and indoor comfort throughout the year according to specific seasonal challenges.

Incorporating and employing one or more the above embodiments provides a comprehensive solution to design the extreme weather ventilated structures for use with electrolyzer systems that maintains continuous, non-forced air flow to the system 10. This helps to prevent against hazardous gas buildup within the system 10 or adjoining buildings and mitigates the concerns of loss of ventilation systems while also protecting the system from extreme weather conditions. These features also optimize indoor air quality, energy efficiency and protect the building from structural damage by minimizing turbulence around the structure while safeguarding against environmental factors. Using louvers as baffling walls adapts ventilation to changing weather patterns. Using similar structures for power transformers and hydrogen compressors increases the lifespan thereby ensuring safety and reliability. This approach bolsters a structure's capacity to withstand and function effectively in harsh weather conditions.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together and in various possible combinations of various different features of different embodiments combined to form yet additional alternative embodiments, with all equivalents thereof.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/m L” should also be understood to provide support for the range of “50 mg/m L to 80 mg/m L.”

Features described above, as well as those claimed below, may be combined in various ways without departing from the scope hereof. It should thus be noted that the matter contained in the above description or shown in the accompanying drawings should be interpreted as illustrative and not in a limiting sense. Accordingly, many combinations, permutations, variations and modifications of the foregoing embodiments of inventions not set forth explicitly herein will nevertheless fall within the scope of this disclosure.

1. A hydrogen generation system comprising:
a plurality of hydrogen cabinets, each hydrogen cabinet comprising a hydrogen generator;
a plurality of electronics cabinets;
the plurality of hydrogen cabinets and the plurality of electronics cabinets are positioned around a central duct;
each hydrogen cabinet is fluidly connected to the central duct, wherein ventilated gases from the plurality of hydrogen cabinets are directed to the central duct,
a ceiling structure opposite of a bottom structure;
exterior walls joining the ceiling structure and the bottom structure; and
an interior defined by the ceiling structure, the bottom structure, and the exterior walls, wherein the plurality of hydrogen cabinets and the plurality of electronic cabinets are positioned in the interior, and
wherein the exterior walls include wall elements configured to permit incoming air to move through the exterior walls while hindering movement of wind, moisture, pollutants, or debris through the exterior walls.

2. The hydrogen generation system of claim 1, wherein a first hydrogen cabinet of the plurality of the hydrogen cabinets is positioned on a first side of the central duct and a second hydrogen cabinet of the plurality of the hydrogen cabinets is positioned on a second side of the central duct, and first side of the central duct is opposite of the second side of the central duct.

3. The hydrogen generation system of claim 1, wherein the plurality of hydrogen cabinets and the plurality of electronics cabinets are positioned in an alternating pattern around the central duct.

4. (canceled)

5. The hydrogen generation system of claim 1, wherein the wall elements comprise baffles, baffling structures, louvers, shutters, slats, or combinations thereof.

6. The hydrogen generation system of claim 1, wherein the wall elements include perforations, lattices, openings, or combinations thereof.

7. The hydrogen generation system of claim 1, the wall elements comprise a first layer of baffling walls and a second layer of baffling walls.

8. The hydrogen generation system of claim 1, the wall elements comprise a first layer of baffling walls and a second layer of baffling walls, and the first layer interlocks with the second layer of baffling walls.

9. The hydrogen generation system of claim 1, wherein the system is configured to operate in extreme weather conditions.

10. The hydrogen generation system of claim 1, wherein the plurality of hydrogen cabinets and the plurality of electronics cabinets are positioned in the interior and are protected from direct contact with wind, moisture, debris or pollutants.

11. The hydrogen generation system of claim 1, wherein the system is configured for outdoor use.

12. The hydrogen generation system of claim 1, wherein the system includes a multiple stories.

13. A hydrogen generation system for use during extreme weather conditions, comprising:
a ceiling structure generally opposite of a bottom structure;
exterior walls joining the ceiling structure and the bottom structure;
an interior defined by the ceiling structure, the bottom structure, and the exterior walls;
the exterior walls include wall elements configured to permit incoming air to move through the exterior walls while hindering movement of wind, moisture, debris, or pollutants through the exterior walls;
a plurality of hydrogen cabinets, each hydrogen cabinet comprising a hydrogen generator;
a plurality of electronics cabinets;
the plurality of hydrogen cabinets and the plurality of electronics cabinets are positioned in the interior;
each hydrogen cabinet is fluidly connected to a central duct, wherein the central duct extends to the ceiling structure, the central duct includes an upper opening, and the upper opening is at the ceiling structure; and
wherein ventilated gases from the plurality of hydrogen cabinets are directed to the central duct.

14. The hydrogen generation system of claim 13, wherein the wall elements comprise baffles, baffling structures, louvers, shutters, slats, or combinations thereof.

15. The hydrogen generation system of claim 13, wherein the wall elements include perforations, lattices, openings, or combinations thereof.

16. The hydrogen generation system of claim 13, the wall elements comprise a first layer of baffling walls and a second layer of baffling walls.

17. The hydrogen generation system of claim 13, the wall elements comprise a first layer of baffling walls and a second layer of baffling walls, and the first layer interlocks with the second layer of baffling walls.

18. The hydrogen generation system of claim 13, wherein the wall elements are removable and replaceable.

19. (canceled)

20. The hydrogen generation system of claim 13, wherein the plurality of hydrogen cabinets and the plurality of electronics cabinets are positioned around the central duct.

21. The hydrogen generation system of claim 13, wherein each of the plurality of hydrogen cabinets is fluidly connected to the central duct via secondary ducts.
